(19) United States
(12) Patent Application Publication
(10) Pub. No.: US 2024/0065279 A1
(43) Pub. Date: Feb. 29, 2024

(54) METHOD OF TREATING A NATURALLY LEAVENED BAKED PRODUCT, BY INJECTING A POST-OVEN SWEETENING AND PRESERVATIVE SOLUTION AND RELATED BAKED PRODUCT

(71) Applicant: BAULI S.P.A., Castel d'Azzano (Verona) (IT)

(72) Inventor: Aldo RIGHI, Castel d'Azzano (Verona) (IT)

(21) Appl. No.: 18/259,883

(22) PCT Filed: Jan. 11, 2022
(86) PCT No.: PCT/IB2022/050170

§ 371 Date: Jun. 29, 2023

(30) Foreign Application Priority Data
Jan. 13, 2021 (IT) 102021000000524

(51) Int. Cl. A21D 15/00

(52) U.S. Cl. CPC A21D 15/00

(57) ABSTRACT

A method of treating a naturally leavened and baked product by injecting a post-oven sweetening and preservative injectable solution is provided. The method involves preparing a leavened product, preparing a sweetening and preservative injectable solution that includes water and sweeteners including simple sugars, oligosaccharides and/or polyalcohols dissolved in water, baking the leavened product in an oven, and, after baking, injecting the sweetening and preservative injectable solution into the leavened and baked product.

### FIELD OF APPLICATION

The present invention relates to a method of treating a naturally leavened baked product by injecting a post-oven sweetening and preservative solution and to the related baked product.

### PRIOR ART

As is known, in the field of the production of leavened baked products, dips are used in order to increase the shelf-life of the product. Said dips are aqueous solutions containing alcohol which are injected into the leavened and baked product in order to increase the aqueous content thereof and therefore increase the internal humidity and softness thereof.

In fact, a goal of dipping is to increase the shelf-life of the product, preventing the product from drying out excessively over time.

Known dip compositions, based on alcohol, however, have some drawbacks and limitations.

In fact, the presence of free water, i.e. not bound in bonds with fibers or proteins or in the solubilization of simple sugars or other water-soluble substances, may be used by bacteria, molds and yeasts for their growth and proliferation. Therefore, the dips of known solutions may lead to the undesired proliferation of such microorganisms.

To counter this phenomenon it is therefore known in the art to add further preservative substances as well as to increase the alcohol content in the dip. In this way, however, the dip may negatively impact the organoleptic properties of the final product.

### DISCLOSURE OF THE INVENTION

Thus, there is a need to resolve the cited drawbacks and limitations in reference to the prior art.

Such need is met by a method of treating a naturally leavened baked product by injecting a post-oven sweetening and preservative solution according to claim 1.

### DESCRIPTION OF THE DRAWINGS

Further features and advantages of the present invention will become more apparent from the following description of preferred and non-limiting embodiments thereof, in which:

FIG. 1 shows a schematic perspective view of a post-oven injection step of a sweetening and preservative solution in a leavened product, according to an embodiment of the present invention.

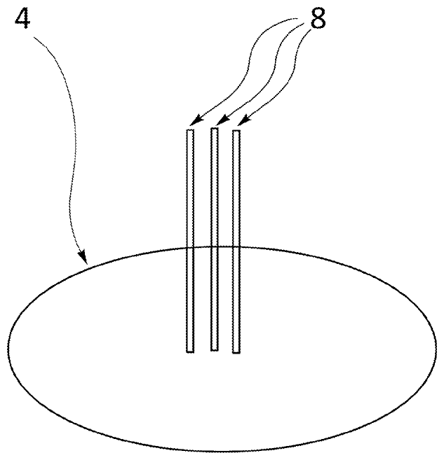

The elements or parts of elements common to the embodiments described hereinafter will be indicated with the same reference numerals.

### DETAILED DESCRIPTION

With reference to the aforementioned FIGURES, the reference numeral 4 globally indicates a naturally leavened, leavened and baked product intended to be soaked by post-oven injection with a sweetening and preservative solution.

In particular, the leavened product 4, after having undergone leavening, be it with brewer's yeast or with mother yeast, is first of all baked in the oven.

Then upon leaving the oven, the leavened product is injected by injection of a sweetening and preservative solution, better described below.

Said injection occurs by means of a plurality of needles 8, for example three needles 8, inserted inside the leavened product 4 and baked until it reaches the core of the product 4 itself. The indication of the number of 3 needles is merely an example and in no way limiting the scope of protection of the present invention.

According to a possible embodiment of the invention, the injection occurs immediately upon removal of the product 4 from the oven, such that the product 4, already baked, has, during injection, a core temperature of between 90° C. and 99° C.

In general, the injection occurs after baking the product, but not necessarily immediately after the product leaves the oven. In fact, it is possible to carry out such injection even after the product has partially or totally cooled, at the end of its baking in the oven. For example, it is possible to carry out the injection, after the product 4 has left the oven, so that the leavened and baked product 4 has at least partially cooled and, during the injection, has a core temperature lower than or equal to 80° C. In this way, it is possible to inject additives and thermolabile ingredients, such as flavorings, enzymes or vitamins, into the baked product which would otherwise suffer significant thermal damage or weight loss during or immediately after baking. These additives and ingredients, once injected at the most suitable temperature, allow the baked product to be improved, in particular its softness, flavor and, in general, its shelf-life to be increased.

The sweetening and preservative injectable solution comprises water and sweetening substances such as simple sugars, oligosaccharides and/or polyols dissolved in water.

According to a possible embodiment of the present invention, the simple sugars belong to a group comprising monosaccharides such as glucose, galactose or fructose, disaccharides such as sucrose, maltose or lactose, or oligosaccharides.

According to a possible embodiment of the present invention, the injectable solution contains a percentage by weight of simple sugars and/or oligosaccharides of between 25% and 65%.

Simple sugars are injected in order to correct the organoleptic properties of the baked product, in order to modify the taste of the baked product at the end of baking, but also in order to increase the shelf-life and softness of the product, without said sugars being in any way able to influence or be modified in the previous leavening and baking steps.

According to a possible embodiment of the present invention, the polyalcohols belong to a group comprising sorbitol, maltitol, mannitol, lactitol, xylitol and isomalt.

According to a possible embodiment of the present invention, the injectable solution contains a percentage by weight of polyalcohols of between 25% and 35%.

Polyalcohols are injected in order to correct the organoleptic properties of the baked product, in order to modify the taste of the baked product at the end of baking, but also in order to increase the shelf-life of the product, without said polyalcohols being in any way able to influence or be modified in the previous leavening and baking steps.

According to a possible embodiment of the present invention, the injectable solution also contains ethyl alcohol as a preservative, and in particular the injectable solution contains a percentage by weight of ethyl alcohol of between 3% and 15%.

The optional presence of ethyl alcohol gives the product further shelf-life qualities, without altering the organoleptic characteristics thereof, also because it is present in moderate quantities.

According to a possible embodiment of the present invention, the injectable solution contains other food preservatives other than ethyl alcohol.

According to a possible embodiment of the present invention, the food preservatives belong to a group comprising sorbic acid and its salts or propionic acid and its salts.

According to a possible embodiment of the present invention, the injectable solution contains a percentage by weight of flavors of less than 1%.

Flavors are injected in order to correct the organoleptic properties of the baked product, in order to modify the taste of the baked product at the end of baking without the flavors being in any way able to influence or be modified in the previous leavening and baking steps.

Preferably, the injectable solution has a water activity at 25° C. of between 0.820 and 0.900.

According to an embodiment of the present invention, the dosage of sweetening and preservative solution may range from 2% to 7% of the weight of the product to which it is added or injected.

In this way, it is possible to raise the sugar content of the final product between 0.5% and 4.5% without negative effects on leavening, as this additional sugar content is introduced post-baking, therefore post-leavening.

In this way, an increase in the humidity of the finished product between 0.9% and 3.2% is also obtained. Humidity refers to the total water content in the product. Therefore, the softness of the product is also improved.

In the doses indicated, the concentration of ethyl alcohol in the finished product which, as seen, is entirely optional, ranges from 0.3% to 1% so as not to alter the organoleptic characteristics thereof, as it is present in a decidedly moderate quantity.

As may be appreciated from the above description, the method of treatment described above allows the drawbacks of the prior art to be overcome.

In particular, the “post-oven” addition of monosaccharides such as glucose, galactose or fructose, of disaccharides such as sucrose, maltose or lactose, and/or oligosaccharides, or of other sweetening substances such as for example the polyalcohols sorbitol, maltitol, mannitol, lactitol, xylitol or isomalt allows imparting greater sweetness to the finished product, without requiring an excessive presence of these sugars or polyalcohols in the dough.

In fact, since these are naturally leavened products, a high concentration of sugars or polyalcohols in the dough would depress the leavening carried out by the mother yeast and/or the brewer's yeast due to an important increase in osmotic pressure.

Furthermore, in the case of simple sugars, the fermentation carried out by yeasts always leads to a reduction in the quantity of these sugars in the leavened and subsequently baked product, thus reducing the sweetness of the finished product.

The “post-oven” addition of a sweetening solution according to the present invention also allows the use of intensive sweeteners, such as for example aspartame, which are sensitive to heat treatments and which would decompose at oven baking temperatures. In this case, adding the sweetening solution after baking in the oven allows them to be used in absolute tranquility.

The addition of flavoring substances to the sweetening solution injected “post oven” also allows the use of thermolabile aromatic substances, which would not overcome the thermal barrier of baking, as well as the use of lower quantities of flavors which, being mostly volatile substances, are usually partly “lost” by evaporation during baking.

The “post-oven” addition of a sweetening solution also allows the humidity and softness of the finished product to be increased without excessively increasing the activity value of the water, or aw, in the finished product.

As is known, the shelf-life of food products in fact depends on the activity value of water, i.e. on the content of free water. In fact, it is the so-called free water, that is water not “bound” in bonds with fibers or proteins or in the solubilization of simple sugars, which may be used by bacteria, yeasts and molds for their growth. By injecting a sugar solution instead of just water (or water and alcohol), the softness and swallowability of the product are improved without increasing the risk of microbial proliferation.

Another advantage deriving from the use of sugar solutions is given by the wetting property of the sugars themselves, a property that allows the risk of mold on the surface of the product to be eliminated.

If only water (or water and alcohol) is used, as occurs in known solutions, any dripping on the product would create an area with very high humidity on the surface of the product.

Even the possible presence of alcohol in the drops on the surface of the product would not constitute a real protection, since on the surface of the hot product there would be a rapid evaporation of the alcoholic component, and therefore the nullification of the protection against molds.

On the other hand, in the case of the presence of sugars, according to the present invention, in case of dripping the surface would be “wet” by a solution, as seen above, with less free water and therefore with less risk of mold.

Those skilled in the art, in order to meet contingent and specific requirements, may make numerous modifications and variants to the treatment methods described above.

The scope of protection of the invention is defined by the following claims.

What is claimed is:

1. A method of treating a leavened and baked product by injecting a post-oven sweetening and preservative solution, the method comprising:
preparing a leavened product,
preparing a sweetening and preservative injectable solution comprising water and sweetening substances such as simple sugars, oligosaccharides and/or polyalcohols dissolved in water,
baking the leavened product in an oven, and
at the end of baking, injecting said sweetening and preservative injectable solution into the leavened and baked product.

2. The method of treating a leavened and baked product according to claim 1, wherein the simple sugars are selected from the group consisting of monosaccharides such as glucose, galactose or fructose, disaccharides such as sucrose, maltose or lactose, and oligosaccharides.

3. The method of treating a leavened and baked product according to claim 1, wherein the sweetening and preservative injectable solution contains a percentage by weight of simple sugars of between 25% and 65%.

4. The method of treating a leavened and baked product according to claim 1, wherein the polyalcohols are selected from the group consisting of maltitol, sorbitol, mannitol, lactitol, xylitol, and isomalt.

5. The method of treating a leavened and baked product according to claim 1, wherein the sweetening and preservative injectable solution contains a percentage by weight of polyols polyalcohols of between 25% and 35%.

6. The method of treating a leavened and baked product according to claim 1, wherein the sweetening and preservative injectable solution contains a percentage by weight of ethyl alcohol of between 3% and 15%.

7. The method of treating a leavened and baked product according to claim 1, wherein the sweetening and preservative injectable solution contains food preservatives selected from the group consisting of sorbic acid and its salts and propionic acid and its salts.

8. The method of treating a leavened and baked product according to claim 1, wherein the sweetening and preservative injectable solution contains a percentage by weight of flavourings of less than 1%.

9. The method of treating a leavened and baked product according to claim 1, wherein the sweetening and preservative injectable solution has a water activity at 25° C. of between 0.820 and 0.900.

10. The method of treating a leavened and baked product according to claim 1, wherein injecting the sweetening and preservative injectable solution occurs by a plurality of needles inserted inside the leavened and baked product until a core of said leavened and baked product is reached.

11. The method of treating a leavened and baked product according to claim 1, wherein injecting the sweetening and preservative injectable solution occurs immediately upon removal of the leavened and baked product from the oven, such that the leavened and baked product has, during injection, a core temperature of between 90° C. and 99° C.

12. The method of treating a leavened and baked product according to claim 1, wherein injecting the sweetening and preservative injectable solution occurs after the leavened and baked product leaves the oven, such that the leavened and baked product has at least partially cooled and has, during injection, a core temperature lower than or equal to 80° C.

13. The method of treating a leavened and baked product according to claim 1, wherein a dosage of the sweetening and preservative injectable solution ranges from 2% to 7% of the weight of the leavened and baked product in which said sweetening and preservative injectable solution is injected.

14. The method of treating a leavened and baked product according to claim 1, further comprising the step of raising, post-baking, sugar content of the leavened and baked product to between 0.5% and 4.5%.

15. The method of treating a leavened and baked product according to claim 1, further comprising the step of raising, post-baking, humidity of the leavened and baked product to between 0.9% and 3.2%.

16. A leavened and baked product treated according to the method of treating a leavened and baked product of claim 1.
